(19) United States
(12) Patent Application Publication
(10) Pub. No.: US 2009/0085725 A1
(43) Pub. Date: Apr. 2, 2009

(54) VEHICLE OPERATION SYSTEM AND METHOD

(76) Inventors: Leah Faith Brookner, Portland, OR (US); George Michael Brookner, Norwalk, CT (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/864,399

(22) Filed: Sep. 28, 2007

(51) Int. Cl. H04Q 5/22

(52) U.S. Cl. 340/10.41

(57) ABSTRACT

A compliance control system for ensuring compliance with regulatory requirements for operating a vehicle. Compliance data is received from a token or another source, is evaluated to determine compliance status, and the operation of the vehicle can be affected based upon the determined compliance status.

### FIELD OF THE INVENTION

The field of the invention is vehicle operation, and in particular technical measures for ensuring compliance with regulatory requirements for operating a vehicle.

### BACKGROUND OF THE INVENTION

Various regulatory requirements can be imposed upon the owners of vehicles. For example, an automobile owner in the United States is required to register her vehicle with the appropriate governmental authority, which is often the Department of Motor Vehicles (“DMV”) of the State in which the car is domiciled. A registration period is typically a year, at the end of which the registration expires and has to be renewed.

Another example of a regulatory requirement is to have the automobile periodically inspected by a mechanic who is certified by the State to ensure that the vehicle is safe to be on the road. The mechanic inspects various aspects of the vehicle (e.g., the brakes, signal lights, tires, exhaust emissions, etc.) and can certify that the vehicle meets certain minimum State requirements.

Another example of a regulatory requirement is to mandate that the driver purchase and maintain a minimum amount of liability insurance for the vehicle. Liability insurance helps to ensure that any damage or injuries caused by operating the vehicle will be at least partly compensated by the insurance company. When a driver does not have insurance, those harmed by the driver may not be adequately compensated.

Compliance with regulatory requirements is often signified by the issuance of a token by an authority empowered to certify such compliance (a “certification authority.”) An example of such a token is a sticker that is meant to be applied to a vehicle. For example, known inspection stickers are meant to be affixed to the inside of a vehicle's windshield and include information such as the jurisdiction in which the vehicle was inspected and an expiration date. The vehicle must be inspected again on or before the expiration date. Known registration stickers are also meant to be affixed to the inside of a vehicle windshield and include information about the jurisdiction in which the vehicle is registered and an expiration date. Another known registration token is a month and year sticker meant to be affixed to the vehicle's license plate. The month and year signify that the registration expires on the last day of the month in the year indicated by the stickers.

Enforcing compliance with regulatory requirements can be difficult using tokens such as stickers. Police can set up roadblocks and visually check vehicles as they pass, ordering those without up-to-date stickers to the side of the road, where they can be ticketed. A ticket often includes a summons that can be satisfied by mailing a fine amount to a local court, along with a signed promise to update the registration. Roadblocks are labor intensive, expensive and limited in scope. They are therefore not often employed and compliance is instead enforced as a routine part of traffic stops. Only a very small fraction of vehicles on the road are subject to traffic stops, so enforcement of compliance is extremely limited and spotty.

As a result of the inefficient and incomplete enforcement of regulatory requirements such as registration, inspection, insurance, etc., many vehicles on the road at any given time are not registered, have not been recently inspected and may be unsafe, and the driver does not carry even a minimum amount of liability insurance. A poor driving record can escalate the cost of insurance. Poor drivers who are unable to afford the higher rate may continue to drive without insurance. What is needed is a more effective enforcement mechanism for ensuring that vehicles and drivers comply with regulatory requirements.

### BRIEF DESCRIPTION OF THE DRAWINGS

FIG. 1 shows an apparatus in accordance with an embodiment of the present invention.

FIG. 2 shows a system in accordance with an embodiment of the present invention.

FIG. 3 shows a method in accordance with an embodiment of the present invention.

### DETAILED DESCRIPTION

In accordance with an embodiment of the present invention, compliance with the regulatory requirements for driving a vehicle can be enforced by technical mechanisms that can alter the operation of the vehicle if some or all of the requirements have not been met.

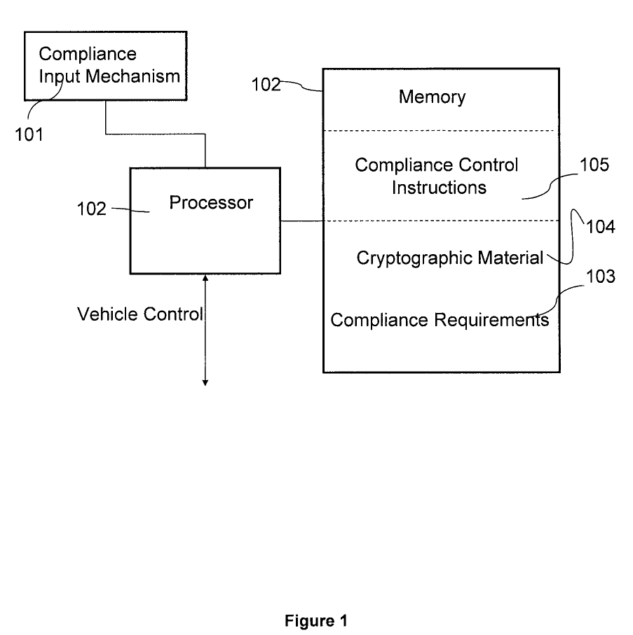

An apparatus in accordance with an embodiment of the present invention is shown in FIG. 1. A compliance input mechanism 101 (also known as a receiver) can convey a compliance signal to a processor 102 onboard the vehicle that is adapted to alter the way the vehicle operates. In one embodiment, the compliance input mechanism is a Radio Frequency Identifier (RFID) reader that can operate in conjunction with one or more RFIDs that can advantageously be embedded in a sticker (a “compliance sticker”) issued by a certification authority. For example, a registration sticker having a RFID embedded therein may be issued by a State agency that certifies that a vehicle has been properly registered. The compliance input mechanism can query the RFID in the sticker and send the signal received from the RFID to processor 102. In another embodiment, compliance input mechanism 101 can be a smart card reader that can operate in conjunction with a smart card capable of storing compliance data for one or more certification authorities. For example, the smart card may store compliance data for a State registration, a State inspection and for insurance. The smart card can be interfaced with the smart card reader, which can convey whatever compliance information is stored on the card to processor 102. In yet another embodiment, compliance input mechanism 101 can be a CD or DVD player onboard the vehicle that can operate with a special CD or DVD that can carry compliance data. The CD or DVD player can read the compliance information from a CD or DVD inserted by a user and convey the compliance data to processor 102. In yet another embodiment, compliance input mechanism 101 can be a function of a vehicle radio that can convey compliance information and authentication information (e.g., a Personal Identification Number (PIN)) through buttons that can also be used for other purposes, e.g., selecting a radio station, playing a DVD, setting a vehicle clock, etc. The user can manually enter one or more codes indicating compliance status that can be conveyed to processor 102. In yet another embodiment, compliance input mechanism 101 can be a receiver that is communicatively coupled to a server through a network, where the server can send compliance and other information. For example, the server can be operated by or on behalf of a State Department of Motor Vehicles, a State taxation authority, etc., and can provide compliance data, compliance requirements, software updates, cryptographic key material updates, etc. Compliance input mechanism 101 can also include means for authenticating a user, such as a biometric fingerprint reader, iris reader, facial recognition system, etc.

Processor 102 can be a general purpose processor, such as a Pentium microprocessor made by the Intel Corporation, an Application Specific Integrated Circuit that embodies at least a part of the method in accordance with the present invention in its hardware and/or firmware, or any suitable processor.

Processor 102 is coupled to memory 103, which can be any device adapted to store digital information, such as RAM, ROM, a hard disk, flash memory, etc. Processor 102 can send signals to the onboard vehicle control system to affect the operation of the vehicle based at least partly on the compliance status as determined from compliance data received by processor 102 from compliance input mechanism 101. In some embodiments, processor 102 can directly affect the operation of the vehicle.

Memory can also store compliance requirements data 103, cryptographic key material 104 and compliance control instructions 105 adapted to be executed by the processor to analyze compliance control signals to determine if the vehicle and/or the user meet compliance requirements, and to determine and cause various actions if some or all of the requirements are not met. In one embodiment of the present invention, the vehicle is prevented from starting if some or all of the requirements are not met. In another embodiment, its maximum speed is limited. In another embodiment, its lights flash in a predetermined pattern if some or all of the requirements are not met to alert authorities on the road that the vehicle is not in compliance. In yet another embodiment, a signal is sent through a network, such as a cellular telephone system if all of the requirements are not met and a user attempts to, or actually, operates the vehicle. The signal can be sent to the authorities indicating that the vehicle is being operated without full compliance. The signal can include geolocation information, e.g., based upon GPS technology. Upon receiving the signal, the authorities can take appropriate action, e.g., issue a warning, issue a ticket, dispatch a patrol car, etc. A medium can store compliance control instructions adapted to be executed by a processor. The medium may be, for instance, a CD, flash memory, a hard disk, RAM, ROM, etc. Such a medium can be provided as “software” for performing all or part of the method in accordance with an embodiment of the present invention.

Instructions adapted to be executed by the processor in accordance with an embodiment of the present invention can be stored in memory at the vehicle factory or later stored using any suitable mechanism, such as by download from a wireless or wired network to a receiver that can be included in the apparatus and stored in memory, from a smart card, a CD, a hard disk, etc. Existing vehicle systems can be used for such storage of software and updates. For example, should the software be CD-based, a CD may be loaded into the vehicle's CD player as a “data CD” whose contents can be written to the vehicle's on board computer. Alternately, software already in the computer may be validated and/or activated using a key or pass code. The key or pass code may be entered using buttons on the vehicle's clock or radio system. Upon entry of the proper code, the software may be activated. Likewise, inspection, registration and insurance data may also be entered using any suitable data entry mechanism in the vehicle (e.g., radio, CD, clock controls, etc.) and stored in memory of the computer system.

An embodiment of the invention can superimpose the legal requirements for motor vehicle registration and insurance into the vehicle's onboard computer system. This can function to assure that a motor vehicle is properly registered and insured as a precondition for operation. An integrated system can be incorporated to interface with a vehicle's existing on board computer so as to prevent the operation of the vehicle should said vehicle not be registered or insured properly or otherwise comply with regulatory requirements.

The present invention can advantageously provide measures that ensure that a compliance token (e.g., a sticker with an RFID, a smart card, a compliance code to be manually entered, a CD, etc.) is not improperly shared. For example, user A of vehicle A may receive a compliance token from a certification authority that signifies user A's and/or Vehicle A's compliance with regulatory requirements. User B and/or vehicle B may not satisfy such requirements. User A may share his token with user B to improperly attempt to leverage A's compliance to permit B to operate as if B were in compliance. To prevent this, the compliance data issued to A can be made specific to vehicle A. This may be accomplished by having a private key stored at the vehicle computer system and making the corresponding public key available to a certification authority. The certification authority can use A's public key to digitally sign the compliance data, producing an anti-sharing signature. A compliance data anti-sharing module in vehicle A can use A's private key to verify the anti-sharing signature. A compliance control module can make the successful verification of the anti-sharing module a condition for permitting the normal operation of the vehicle. Since B's private key cannot be used to successfully verify the signature, A's compliance data will not work for B. The private keys should be stored in a tamper-resistant way to prevent sharing of such keys. Other means besides the use of a public/private key can be used to make the compliance data specific to a vehicle. For example, each vehicle can have its own unique key that is confidentially shared with the certification authority. The certification authority can hash the compliance data and encrypt the hash with the symmetric key for that vehicle. Alternatively, the certification authority can encrypt all of the compliance data. Other ways to make the compliance data specific to the vehicle are known in the art.

Another concern is counterfeiting. The present invention can advantageously provide mechanisms for preventing the use of forged compliance data that is not issued by a genuine certification authority. Each certification authority can have its own private key and make its public key available to vehicles. The certification authority can digitally sign its compliance data, producing an anti-counterfeiting signature. At the vehicle, a compliance data anti-counterfeiting module can verify the anti-counterfeiting signature using the certification authority's public key. The vehicle's compliance control module can make the successful verification of the certification authority's signature a necessary condition for permitting the normal operation of the vehicle. The public keys of certification authorities can be embedded in the apparatus in accordance with an embodiment of the present invention at the factory. Alternatively, keys can be distributed in software updates, or they can be sent via secure wireless communication to the vehicle. Other mechanisms for verifying the certification authority can also be used, such as maintaining a unique, shared symmetric key between each vehicle and a certification authority. The key should be kept confidential.

Various features of the present invention will be described in connection with a “smart sticker,” e.g., a windshield sticker with an embedded RFID device that is issued by a certification authority. This is meant to illustrate, not to limit, the scope of the present invention. One of skill in the art will recognize that at least several of these features may also be implemented with other embodiments encompassed by the claims, such as smart card, a CD, manual entry of data, etc.

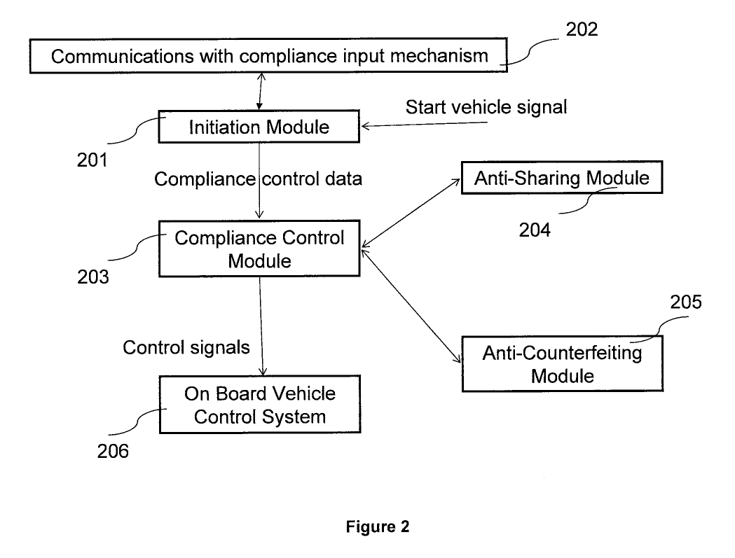

FIG. 2 shows a smart sticker system in accordance with an embodiment of the present invention. A signal is sent to an initiation module 201 that sends a signal to RFID module 202. The signal may be sent, for example, in response to a user attempting to start the vehicle. In other embodiments besides the smart sticker, the initiation module may be activated by pressing buttons on the CD player, by plugging in a smart card, by a biometric authentication event, etc. In response, RFID module 202 sends a signal querying a RFID embedded in a smart sticker placed on the vehicle, e.g., on the windshield. The RFID module 202 sends a signal to compliance module 203 reporting the data (e.g., a compliance signal) received in response to the query or reporting that no data was received in response to the query. Compliance module 203 sends compliance data to anti-sharing module 204, which can verify that the compliance data is specifically designated for this vehicle. If compliance module 203 receives a successful verification signal from anti-sharing module 204, it sends compliance data to anti-counterfeiting module 205. Anti-counterfeiting module can verify whether the compliance data originated from a genuine certification authority. If compliance module 203 receives a successful verification signal from anti-counterfeiting module 204 and anti-counterfeiting module 205, then compliance module can assess compliance based upon the compliance data.

In one embodiment, compliance module accesses compliance requirements stored in memory. For example, vehicle A may store compliance control requirements for registration, inspection and insurance. Vehicle B may store compliance control requirements for only registration and inspection. Compliance module 203 can determine if compliance data has been received for each and every compliance requirement. If such data has been received for each requirement, then compliance module 203 can permit normal operation of the vehicle. For example, if compliance control module 203 intercepts a vehicle start request made by the user (e.g., the user has inserted and turned an ignition key, which generates a signal that can be intercepted by compliance control module 203), and if compliance control module determines that all of the compliance requirements are met based on compliance data, then compliance module can send the ignition signal to the onboard vehicle control system 206, which can then cause the engine to start.

If control module 203 determines that none of the compliance requirements are met, it can prevent the vehicle from starting, e.g., not send the ignition signal to the onboard vehicle control system 206.

If control module 203 determines that some of the compliance requirements are met and some are not met, it can consult a compliance rule base that can be specified in a compliance rule syntax. A compliance rule can have a predicate and an action. For example, if all requirements are met except insurance, then do not permit vehicle to start. Or, if all requirements are met except inspection and if inspection has expired less than one month ago, then play announcement to user that inspection has recently expired. The expiration date of compliance with a requirement can be included as part of the compliance data. For example, an expiration date can be encoded into a signal returned from an RFID device, can be stored in a smart card, etc. Predetermined announcements can be stored in an embodiment of the present invention. Another rule could be, if registration compliance will expire within thirty days, play reminder message for user. Any suitable response can be provided based upon each and every possibly contingency as it can be understood from compliance data, and in some cases, from other information.

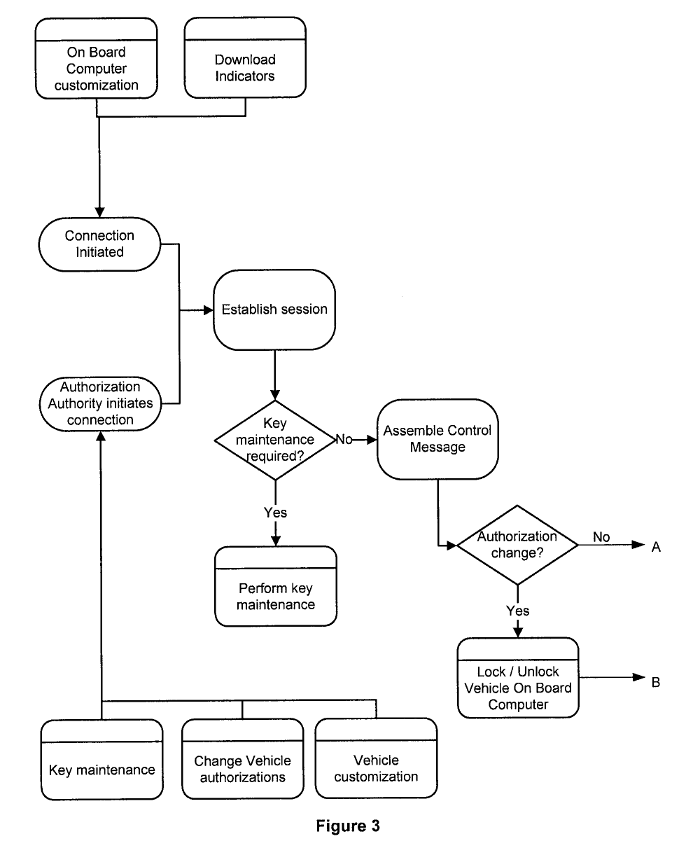

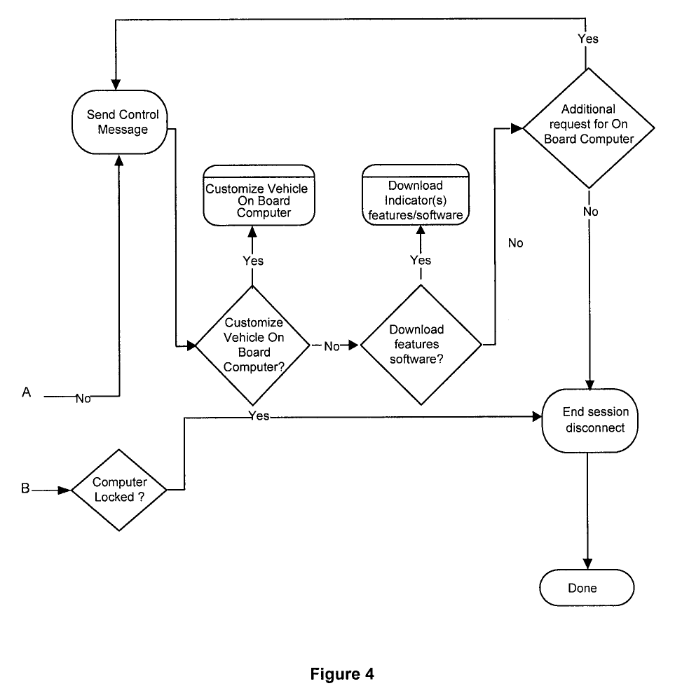

FIG. 3 shows a method in accordance with an embodiment of the present invention. The onboard vehicle control system can be customized by adding additional hardware and/or software. Indicators of compliance requirements can be loaded onto the customized system, either at the factory or later, e.g., via wireless transmission or using the same mechanisms used for compliance data input. A connection can be initiated with the compliance control function, e.g., the compliance control functionality can be activated as the result of an activation signal from a certification authority via a wireless network, by an ignition signal at the vehicle, etc. Software can be updated, new compliance requirements can be sent, new compliance data can be sent, the system can determine if any changes are to be made to any cryptographic material, e.g., updating public keys of certification authorities, updating symmetric keys, reprovisioning the vehicle key material, etc. Compliance data can be assessed against requirements. If the data indicates that the requirements are met, then the normal operation of the vehicle can be enabled.

The foregoing is meant to illustrate and not to limit the scope of the claimed invention. One of skill in the art will recognize that the claims encompass additional embodiments beyond those discussed above. For example, embodiments of the present invention may affect the operation of the vehicle in other appropriate ways based upon the determined compliance status in accordance with specified conditions. For example, if at least one given regulatory requirement is not complied with, then the vehicle may be permitted to operate only on secondary roads and not on primary roads or only on specified routes. This can be effectuated with an onboard GPS system that can include mapping data to track the location of the vehicle. If a user attempts to drive where not permitted, a warning can be played to the user and the car can be caused to safely slow and eventually stop. Likewise, non-compliance or an upcoming expiration date for compliance can trigger appropriate messages to be played to the user. For example, the user can be told that the vehicle will not start because it is not in compliance (e.g., “This vehicle will not start until it is properly registered.”) Another message may send instructions to the driver to pull over because the vehicle will be slowed and stop within a given period of time. The compliance module can cause the vehicle control system to take any appropriate action, such as slowing the vehicle, stopping the vehicle, causing messages to be played (e.g., via a speaker, shown on a display in the vehicle cockpit, etc.), causing emergency lights to activate, causing the lights to flash in a given fashion, etc. These and other embodiments are encompassed by the claims.

What is claimed is:

1. A system for ensuring compliance with regulatory requirements for operating a vehicle, comprising:
a receiver adapted to receive compliance data from a compliance device;
a compliance module coupled to the receiver, said compliance control module adapted to receive a compliance signal from the receiver and to evaluate the compliance signal to determine the compliance status of the vehicle with respect to a regulatory requirement and to affect the operation of the vehicle.

2. The system of claim 1, further comprising an anti-sharing module that prevents compliance data from being improperly shared among vehicles.

3. The system of claim 1, further comprising an anti-counterfeiting module that verifies whether compliance data has been issued by a genuine certification authority.

4. The system of claim 1, wherein the receiver is at least one from the group of: a Radio Frequency Identifier Device (RFID), a CD player and a smart card reader and the compliance device is at least one from the group of: a vehicle-specific RFID tag embedded in a compliance sticker, a vehicle-specific CD and a vehicle-specific smart card.

5. The system of claim 1, wherein the receiver is a wireless communications device communicatively coupled to a server through a network and the compliance device is the server.

6. The system of claim 1, wherein the compliance module is adapted to inhibit the normal operation of the vehicle if the compliance status indicates that compliance with at least one regulatory requirement has expired.

7. The system of claim 1, wherein the compliance status is compliance with at least one from the group of: vehicle-specific registration regulations, vehicle-specific inspection regulations and vehicle-specific insurance requirements.

8. The system of claim 1, wherein the compliance module causes a warning to be activated if the compliance status indicates that compliance with at least one regulatory requirement is approaching expiration.

9. A method for ensuring compliance with regulatory requirements for operating a vehicle, comprising:
receiving compliance data from a compliance device, wherein the compliance data pertains to at least one of the group of vehicle-specific registration, vehicle-specific inspection and vehicle-specific insurance compliance with regulations;
determining from the compliance data the compliance status of the vehicle; and
based on the compliance status of the vehicle, affecting the operation of the vehicle.

10. The method of claim 9, further including authenticating the compliance data to verify that it is specific to a particular vehicle.

11. The method of claim 9, further including authenticating the compliance data to verify that it originated from a genuine certification authority.

12. The method of claim 9, further including causing the normal operation of the vehicle to be inhibited if the compliance status indicates that the vehicle does not comply with at least one regulatory requirement.

13. The method of claim 9, further including causing a warning message to be activated if the compliance status indicates that compliance with at least one regulatory requirement is approaching expiration.

14. A medium storing instructions adapted to be executed by a processor to ensure compliance with regulatory requirements for operating a vehicle, including:
receiving compliance data from a compliance device, wherein the compliance data pertains to at least one of the group of vehicle-specific registration, vehicle-specific inspection and vehicle-specific insurance compliance with regulations;
determining from the compliance data the compliance status of the vehicle; and
based on the compliance status of the vehicle, affecting the operation of the vehicle.

15. The medium of claim 14, storing further instructions to ensure compliance with regulatory requirements for operating a vehicle, including authenticating the compliance data to verify that it is specific to a particular vehicle.

16. The medium of claim 14, storing further instructions to ensure compliance with regulatory requirements for operating a vehicle, including authenticating the compliance data to verify that it originated from a genuine certification authority.

17. The medium of claim 14, storing further instructions to ensure compliance with regulatory requirements for operating a vehicle, including causing the normal operation of the vehicle to be inhibited if the compliance status indicates that the vehicle does not comply with at least one regulatory requirement.

18. The medium of claim 14, storing further instructions to ensure compliance with regulatory requirements for operating a vehicle, including causing a warning message to be activated if the compliance status indicates that compliance with at least one regulatory requirement is approaching expiration.

19. The medium of claim 17, storing further instructions to ensure that cessation of normal operation of the vehicle does not occur while the vehicle is in operation.

20. The medium of claim 19, storing further instructions to ensure that an attempt to start the vehicle using the ignition system will not cause the vehicle to start.
